(19) United States
(12) Patent Application Publication
(10) Pub. No.: US 2015/0332343 A1
(43) Pub. Date: Nov. 19, 2015

(54) BEHAVIORAL TRACKING SYSTEM AND METHOD IN SUPPORT OF HIGH-ENGAGEMENT COMMUNICATIONS

(71) Applicant: Sailthru, Inc., New York, NY (US)

(72) Inventors: Neil James Capel, New York, NY (US); Ian Bradford White, Brooklyn, NY (US)

(21) Appl. No.: 14/812,701

(22) Filed: Jul. 29, 2015

Related U.S. Application Data
(63) Continuation-in-part of application No. 14/262,361, filed on Apr. 25, 2014.
(60) Provisional application No. 62/030,475, filed on Jul. 29, 2014.

(51) Int. Cl. G06Q 30/02; G06F 17/30

(52) U.S. Cl. CPC G06Q 30/0269; G06F 17/3053; G06Q 30/0277; G06Q 30/0261

(57) ABSTRACT

A processor accesses information representing activity of a plurality of respective users of each of a plurality of Internet web sites and a time associated with the activity. Further, a processor accesses geo-location information representing at least a location of a respective device operated by each of the plurality of respective users. The electronic activity information is processed to determine a respective interest of each of the respective users. A respective targeted communication is generated for each by: calculating a decay value representing a decline of the determined interests of the respective users; weighting the respective determined interests of the users to represent the decline; and selecting content for inclusion in the targeted communication for each of respective users. Further the generated respective targeted communication is transmitted, by a processor, to each respective one of the plurality of users via a communication device over a data-communication network.

### CROSS-REFERENCE TO RELATED APPLICATIONS

The present invention is based on and claims priority to U.S. Provisional Patent Application Ser. No. 62/030,475, filed Jul. 29, 2014 and entitled BEHAVIORAL TRACKING SYSTEM AND METHOD IN SUPPORT OF HIGH-ENGAGEMENT COMMUNICATIONS, and is a continuation-in-part of U.S. patent application Ser. No. 14/262,361, filed Apr. 25, 2014 and entitled BEHAVIORAL TRACKING SYSTEM AND METHOD IN SUPPORT OF HIGH-ENGAGEMENT COMMUNICATIONS, the entire contents of each of which are incorporated by reference herein as if expressly set forth in their respective entireties.

### FIELD OF THE INVENTION

The present application relates, generally, to networks and, more particularly, to providing operability for engaging consumers.

### BACKGROUND OF THE INVENTION

Various providers of goods and services (e.g., merchants) continue to seek new ways to engage customers. Push notifications, for example, enables a merchant to send a message to a group of users at some specific time, for example to the users' mobile devices. When received, the devices show an alert, and the next time the users activate their devices, the notification is visible. The users then decide the next step.

Unfortunately, it is recognized that too often users simply take no further action and/or forget about the message they just received.

### BRIEF SUMMARY THE INVENTION

In accordance with one or more implementations of the present application, a system and method is disclosed that include a processor configured by executing code accessing electronic activity information representing activity of a plurality of respective users of each of a plurality of Internet web sites and a time associated with the activity. Further, a processor configured by executing code accesses electronic user geo-location information representing at least a location of a respective device operated by each of the plurality of respective users. The electronic activity information can be processed to determine a respective interest of each of the respective users, and a respective targeted communication is generated for each of the plurality of respective users. The respective targeted communications can be generated by: calculating a decay value representing a decline of the determined interests of the respective users; weighting the respective determined interests of the plurality of users to represent the decline of the determined interests as a function of the calculated decay value; and selecting respective content for inclusion in the targeted communication for each of respective users as a function of the electronic activity information, the user geo-location information and the weighted respective determined interests. Further, the generated respective targeted communication is transmitted, by a processor configured by executing code, to each respective one of the plurality of users via a communication device over a data-communication network.

Other features and advantages of the present application will become apparent from the following description of the invention that refers to the accompanying drawings.

### BRIEF DESCRIPTION OF THE DRAWINGS

Further aspects of the present disclosure will be more readily appreciated upon review of the detailed description of its various embodiments, described below, when taken in conjunction with the accompanying drawings, of which:

FIG. 1 shows an example hardware arrangement of computing devices arranged to send and receive information in accordance with an implementation;

FIG. 2 is a block diagram that illustrates functional elements of a computing device in accordance with an embodiment;

FIG. 3 is a block diagram illustrating a network of parties in accordance with one or more implementations of the present application; and

FIG. 4 is a block diagram that illustrates example features and functionality provided in accordance with one or more implementations of present application.

### DETAILED DESCRIPTION OF CERTAIN OF THE EMBODIMENTS

The present application provides a computerized platform that includes one or more modules for users to develop and manage communications, such as email campaigns for their customers. In one or more implementations, the present application can include modules that manage the tracking of user activity, such as click-rates of one or more links that are included in email messages. For example, graphical user interfaces are provided for management of email campaigns, email lists of subscribers for mass mailings, and formatting and transmitting tracking images that are used for tracking rates at which users open and/or interact with email messages. Once tracked, interest-based behavioral personalization can be provided, such as in connection with email campaigns. For example, content from one or more Internet websites can be selected and/or provided automatically into an email campaign, alerts can be defined that operate substantially in real time to filter for specific content, transactional emails using Simple Mail Transport Protocol (“SMTP”) can be transmitted, and geo-located mailing lists or snapshot reports for email campaigns can be provided.

As shown and/or described herein, one or more modules of the present application provide interfaces and options for users to send email messages, including in connection with transaction email messages and email campaigns to large numbers and groups of people rapidly. For example, email campaigns can be provided for newsletters, massive notifications, breaking news, and so on. Moreover, the present application provides options for users to provide customization for their web sites, including as a function of the email campaigns.

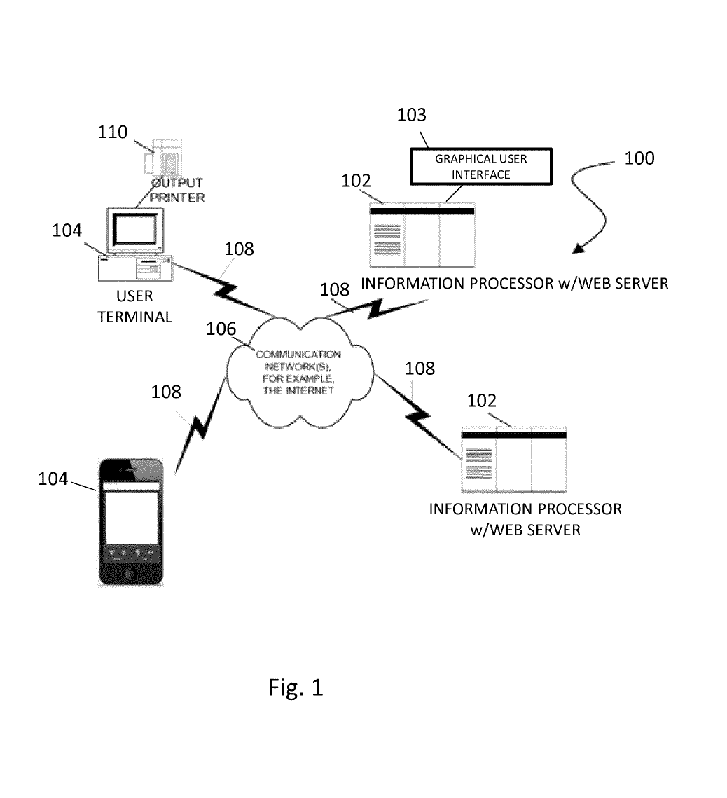

Referring now to the drawings in which like reference numerals refer to like elements, there is shown in FIG. 1 a diagram of an example hardware arrangement that operates for providing the systems and methods disclosed herein, and designated generally as system 100. The example system 100 is preferably comprised of one or more data processing apparatus 102 coupled to one or more user computing devices 104 across communication network 106. User computing devices 104 may include, for example, mobile computing devices such as tablet computing devices, smartphones, personal digital assistants or the like. Further, printed output is provided, for example, via output printers 110.

Data processing apparatus 102 preferably includes all necessary databases for the present invention, including image files, metadata and other information. However, it is contemplated that data processing apparatus 102 can access any required databases via communication network 106 or any other communication network to which data processing apparatus 102 has access. Data processing apparatus 102 can communicate devices comprising databases using any known communication method, including a direct serial, parallel, USB interface, or via a local or wide area network. Database(s) that are accessible by data processing apparatus 102 can contain and/or maintain various data items and elements that are utilized throughout the various operations of the system (100). For example, the database(s) can contain include user information including account information concerning the user's various accounts third-party content and service providers. The database(s) can also include user preferences concerning operation of the system 100 and other settings related to the third-party content and service providers.

User computing devices 104 communicate with data processing apparatus 102 using data connections 108, which are respectively coupled to communication network 106. Communication network 106 can be any communication network, but is typically the Internet or some other global computer network. Data connections 108 can be any known arrangement for accessing communication network 106, such as dial-up serial line interface protocol/point-to-point protocol (SLIPP/PPP), integrated services digital network (ISDN), dedicated leased-line service, broadband (cable) access, frame relay, digital subscriber line (DSL), asynchronous transfer mode (ATM) or other access techniques.

User computing devices 104 preferably have the ability to send and receive data across communication network 106, and are equipped with web browsers to display the received data on display devices incorporated therewith. By way of example, user computing device 104 may be personal computers such as Intel Pentium-class computers or Apple Macintosh computers, but are not limited to such computers. Other computing devices which can communicate over a global computer network such as palmtop computers, personal digital assistants (PDAs) and mass-marketed Internet access devices such as WebTV can be used. In addition, the hardware arrangement of the present invention is not limited to devices that are physically wired to communication network 106. Of course, one skilled in the art will recognize that wireless devices can communicate with data processing apparatus 102 using wireless data communication connections (e.g., Wi-Fi).

System 100 preferably includes software that provides functionality described in greater detail herein, and preferably resides on one or more data processing apparatus 102 and/or user computing devices 104. One of the functions performed by data processing apparatus 102 is that of operating as a web server and/or a web site host. Data processing apparatus 102 typically communicate with communication network 106 across a permanent i.e., unswitched data connection 108. Permanent connectivity ensures that access to data processing apparatus 102 is always available.

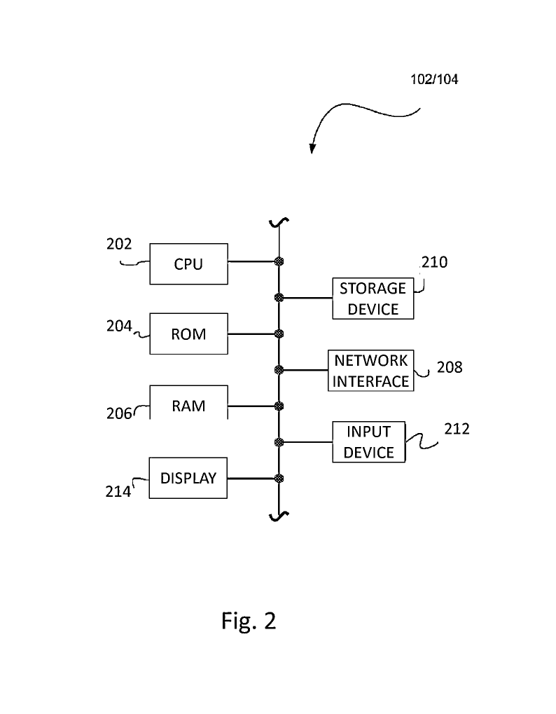

As shown in FIG. 2 the functional elements of each data processing apparatus 102 or computing device 104, and preferably include one or more processors 202 used to execute software code in order to control the operation of data processing apparatus 102, read only memory (ROM) 204, random access memory (RAM) 206 or any other suitable volatile or non-volatile computer readable storage medium, which can be fixed or removable. FIG. 2 also includes one or more network interfaces 208 to transmit and receive data to and from other computing devices across a communication network. The network interface 208 can be any interface that enables communication between the any of the devices (e.g., 102, 104, 110) shown in FIG. 1 includes, but is not limited to, a modem, a Network Interface Card (NIC), an integrated network interface, a radio frequency transmitter/receiver (e.g., Bluetooth, cellular, NFC), a satellite communication transmitter/receiver, an infrared port, a USB connection, and/or any other such interfaces for connecting the devices and/or communication networks, such as private networks and the Internet. Such connections can include a wired connection or a wireless connection (e.g., using the IEEE 802.11 standard known in the relevant art) though it should be understood that network interface 208 can be practically any interface that enables communication to/from the processor 202.

Continuing with reference to FIG. 2, storage device(s) 210 can be included such as a hard disk drive, floppy disk drive, tape drive, CD-ROM or DVD drive, flash memory, rewritable optical disk, rewritable magnetic tape, or some combination of the above for storing program code, databases and application code. In certain implementations, memory 204, 206 and/or storage device(s) 210 are accessible by the processor 202, thereby enabling the processor 202 to receive and execute instructions stored on the memory 204, 206 and/or on the storage 210. Further, elements include one or more input devices 212 such as a keyboard, mouse, track ball and the like, and a display 214. The display 214 can include a screen or any other such presentation device that enables the system to instruct or otherwise provide feedback to the user regarding the operation of the system (100). By way of example, display 214 can be a digital display such as an LCD display, a CRT, an LED display, or other such 2-dimensional display as would be understood by those skilled in the art. By way of further example, a user interface and the display 214 can be integrated into a touch screen display. Accordingly, the display is also used to show a graphical user interface, which can display various data and provide “forms” that include fields that allow for the entry of information by the user. Touching the touch screen at locations corresponding to the display of a graphical user interface allows the user to interact with the device to enter data, control functions, etc. So when the touch screen is touched, interface communicates this change to processor, and settings can be changed or user entered information can be captured and stored in the memory.

One or more software modules can be encoded in the storage device(s) 210 and/or in the memory 204, 206. The software modules can comprise one or more software programs or applications having computer program code or a set of instructions executed in the processor 202. Such computer program code or instructions for carrying out operations or aspects of the systems and methods disclosed herein can be written in any combination of one or more programming languages, as would be understood by those skilled in the art. The program code can execute entirely on one computing device (e.g., data processing apparatus 102) as a stand-alone software package, partly on one device and partly on one or more remote computing devices, such as, a user computing device 104, or entirely on such remote computing devices. In the latter scenario and as noted herein, the various computing devices can be connected to the data processing apparatus 102 through any type of wired or wireless network, including a local area network (LAN) or a wide area network (WAN), or the connection can be made to an external computer (for example, through the Internet using an Internet Service Provider). It should be understood that in some illustrative embodiments, one or more of the software modules can be downloaded over a network from another device or system via the network interface 208. For instance, program code stored in a computer readable storage device in a server can be downloaded over a network from the server to the storage 210.

It is to be appreciated that several of the logical operations described herein are implemented (1) as a sequence of computer implemented acts or program modules running on the various devices of the system 100 and/or (2) as interconnected machine logic circuits or circuit modules within the system (100). The actual implementation is a matter of design choice dependent on the requirements of the device (e.g., size, energy, consumption, performance, etc.). Accordingly, the logical operations described herein are referred to variously as operations, steps, structural devices, acts, or modules. As referenced above, the various operations, steps, structural devices, acts and modules can be implemented in software, in firmware, in special purpose digital logic, and any combination thereof. It should also be appreciated that more or fewer operations can be performed than shown in the figures and described herein. These operations can also be performed in a different order than those described herein.

Thus, the various components of data processing apparatus 102 need not be physically contained within the same chassis or even located in a single location. For example, as explained above with respect to databases which can reside on storage device 210, storage device 210 may be located at a site which is remote from the remaining elements of data processing apparatus 102, and may even be connected to CPU 202 across communication network 106 via network interface 208.

The nature of the present application is such that one skilled in the art of writing computer executed code (software) can implement the described functions using one or more or a combination of a popular computer programming language including but not limited to C++, VISUAL BASIC, JAVA, ACTIVEX, HTML, XML, ASP, SOAP, IOS, ANDROID, TORR and various web application development environments.

As used herein, references to displaying data on user computing device 104 refer to the process of communicating data to the computing device across communication network 106 and processing the data such that the data can be viewed on the user computing device 104 display 214 using a web browser or the like. The display screens on user computing device 104 present areas within system 100 such that a user can proceed from area to area within the system 100 by selecting a desired link. Therefore, each user's experience with system 100 will be based on the order with which (s)he progresses through the display screens. In other words, because the system is not completely hierarchical in its arrangement of display screens, users can proceed from area to area without the need to “backtrack” through a series of display screens. For that reason and unless stated otherwise, the following discussion is not intended to represent any sequential operation steps, but rather the discussion of the components of system 100.

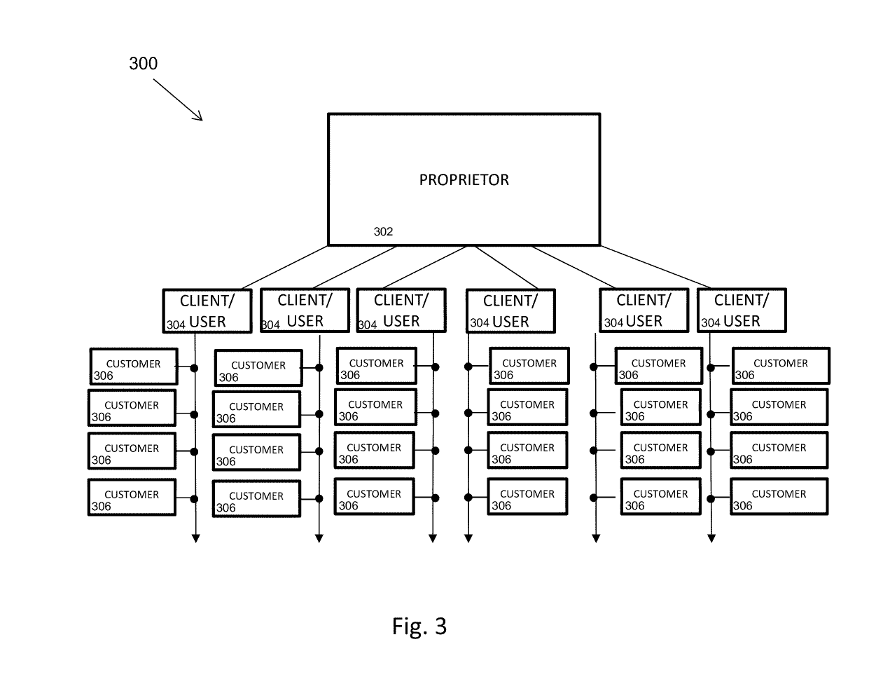

FIG. 3 is a block diagram illustrating a network of parties 300 in accordance with one or more implementations of the present application. As shown in FIG. 3, plurality of clients 304 of proprietor 302 are communicatively coupled together, such as via data processing apparatus 102 and user computing devices 104 and communication network 106. Clients/Users 304 avail themselves of functionality proprietor 302 offers via data processing apparatus 102 substantially as shown and/or described herein. Such functionality is usable by clients/users 304 to service their respective customers 306. Thus and as shown in FIG. 3, a plurality of customers 306 are respectively serviced by clients/users 304 of proprietor 302, including to receive email messages, newsletters, alerts or other content that can be customized for each respective customer 306. In this way, the teachings herein provide for propagation of technology and functionality across many different industries and technologies.

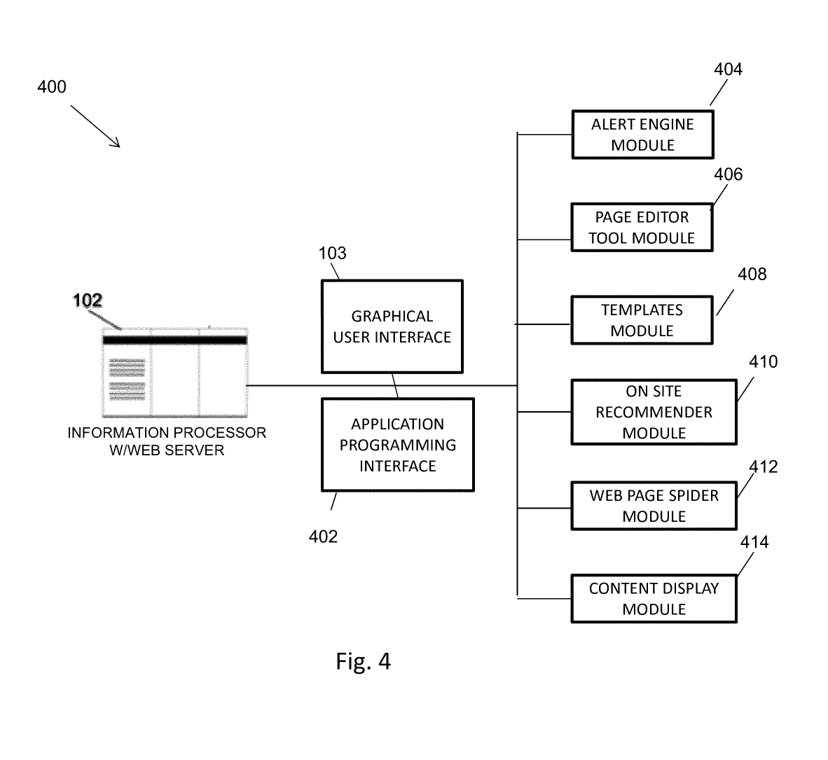

FIG. 4 is a block diagram 400 that illustrates example hardware and software features and functionality provided in accordance with one or more implementations of present application. Included in the arrangement shown in FIG. 4, various modules are programmatically tied to graphical user interface 103 and/or API 402, which are supported by data processing apparatus 102. A non-limiting list of modules provided via graphical user interface 103 and/or application programming interface (API) 402 and illustrated in FIG. 4 include: alert engine module 404, page editor tool module 406, templates module 408, content feed module 410, scheduling module 412, advertisement format module 414 behavioral tracking module 416, on-site recommender module 418 and mobile device tracking module 420.

In one or more implementations, the present application supports APIs 402 for various functionality that enable users 304 to provide customized content to customers 306. Particular selections of customized content may be made in accordance with historical activity and/or behavior of respective customers 306. For example, one customer 306 (e.g., Sarah) typically reads content (e.g., articles) associated with politics, while another customer 306 (e.g., John) typically cares more about sports. Accordingly, content about breaking political updates is selected for and delivered to Sarah and content about a preferred sports team is selected for and delivered to John.

One or more APIs 402 may be made available by download, such as using user computing device 104, and may further be tailored for use for user's 304 respective computing device's 104 programming language and/or operating system. One or more pre-built libraries may be utilized by users' 304 respective computing devices 104, which support customization, for example, with relatively simple programming code provided by users 304. In one or more implementations, users 304 may write code inside an application to cause one or more desired actions to be performed. In some cases, this may be as little as one line of code. With functional automation in place, users 304 are able to spend less time in a web-based interface to define one or more operations associated with an email campaign, which improves the experience for customer 306.

In one or more implementations, one or more APIs 402 include a simple REST-based service. Various functionality provided via APIs 402 can include sending email messages to customers 306, enabling a customer 306 to sign up for subscription services, and scheduling email campaigns to multiple recipients. Other functionality can include defining dates for user subscriptions to email lists, performing background processing tasks, such as subscriber list imports, identify bulk updates of subscriber information, identify export details of subscriber information, and identify status information of an in-progress job.

Furthermore and in one or more implementations, a tracking object, such as a transparent graphic image file (“GIF”) can be provided that is used to track email activity associated with recipients. Tracking objects are effective for recipients who are reading email with images turned on. Tracking objects may be included in email templates and mailing campaigns, and allow users to gather information about recipients. Such information includes, but is not limited to, identifying users who do not open (click on) email messages, identifying those users who do open email messages, identifying the time of day that email messages are opened and identifying geo-location information associated with a customer 306 who reads an email message. In one or more implementations, a tracking object that is provided with an email message is formatted as a logo or other image. The tracking object may be uploaded by user 304 operating a user operating computing device 104 to data processing apparatus 102 via graphical user interface 103. Customers 304 may implement functionality associated with a tracking object, for example, by including a tag, such as an HTML tag (e.g. {beacon}) that, when selected by a recipient of an email message (e.g., customer 306), links the recipient's computing device to an Internet website of the user 304 associated with computing device 104. In alternative embodiments, users 304 may include different tags, such as image tags, to change performance associated with a recipient selecting a tracking object image.

In accordance with one or more implementations of the present application, alert engine module 404 can be configured to provide message alerts, which can be formatted as transactional email messages, to notify customers 306 of new and/or updated content on a website associated with a client/user 304 of user computing device 104. The alert(s) may be provided when a condition matches one or more predefined criteria. For example, a user may want to be notified whenever certain types of products or certain price ranges are released on an e-commerce site associated with a client 304. In another example, a customer 306 may want to be notified when news articles about certain topics are released. In support of alerts, the alert module 404 can be configured to track user preferences and send notifications in accordance with the preferences. Alerts can be provided in basic types, including, for example, real-time alerts and summary alerts. Real-time alerts contain notifications about a single piece of content, and are sent immediately after a piece of content is published. Summary alerts contain information including content published over a specified time period, and are sent at periodic times, such as daily or weekly.

Alert engine module 404 can be provided via user interface 103 and that includes one or more controls (e.g., graphical screen controls), that when selected results in instructions executed by a processor 202 to enable clients 304 to manage alerts. In accordance with one or more implementations, the alert engine module 404 includes a plurality of modules, such as for defining alerts, creating templates, integrating preference information and transmission of alerts.

In one or more implementations, alert module 404 can include a design criteria module 404A that includes one or more controls for users 304 to define one or more variables, such as filters that are used to select and transmit alerts. In one or more implementations, users 304 can define relatively simple filters that match one or more values against tags, metadata or other coded criteria. For example, user 304 is associated with a clothing retail website wants to filter alerts by price (a number), brand (a string), and tags (an array of strings). When criteria meeting these filters are met, the respective customers 306 of user 304 are alerted.

In one or more implementations, page editor tool module 406 (FIG. 4) can be provided and that includes one or more controls that enable users 304 to build custom Internet webpages for the user's 304 website. For example, page editor tool module 406 can include a tool within GUI 103 that is provided for users 304 to create sign-up pages for customers 306 to become email list subscribers. Users 304 can define one or more mailing lists, manage profile data (e.g., name, telephone number, postal code, email address or the like), as well as to define a frequency for receiving email (weekly, monthly, annually, etc.) or options for enabling customers 306 to opt in and out of lists.

Further, template module 408 can include an integrated content pushing module that enables users 304 to push content to customers 306. The present application supports functionality to enable a real-time alert to be sent whenever particular content is published, such as on user 304 website. Content may also be automatically stored, for example, on data processing apparatus 102 for generating and providing summary alerts. In one or more implementations, users 304 utilize a content management system by executing a call to a respective API, whenever a piece of content is first published. In one or more contexts content is formatted to include a title, uniform resource locator (URL), and date, and further may contain any number of tags and a number of custom variables. If a user 304 does not specify a date, a current timestamp may be used in its place.

Examples of details and functionality, included that are associated with modules 404-414 are further shown and described with reference to FIG. 4. FIG. 4 includes data entry display screens associated with defining an ad campaign, including via templates, page editor editors, and scheduling email campaigns and alerts in accordance with one or more implementations of the present patent application.

In one or more implementations, a behavioral-tracking system and method is provided that gathers data on customers' 306 individual interests based on activity, such as on a website or mobile app, via a behavioral tracking module (not shown). This enables custom targeting of customers 306 based on their respective purchases, browsing experience, and explored interests. By gathering and using information such as shown and/or described herein, the number of clicks, page views and user engagement can be increased. Moreover, metadata associated with content is used and interest tags with a customer's 306 interest profile are stored. For example, a customer 306 browses the site of a major tech news site and also interacts frequently with a newsletter provided in accordance with the teachings herein. Through each interaction, information is learned and stored about the customer 306, denoting her clicks on articles about various topics. This also provides an advantage to e-commerce sites by allowing targeting of customers 306 based on purchase intent and history. Moreover, individual user profiles allow for dynamically generated content based on each user's profile and purchase history. User interests are collected based on these tags and weighted compared to the overall interests of users across a user's 304 site. For each user and each tag, a count (e.g., raw count of the number of page views the user has had for that tag) and an interest level is stored. Page views may be calculated for sites containing a corresponding code snippet on respective pages. Interest level compares the customer's 306 count relative to other users across a client's 304 site. Such information can be used, such as in connection with an algorithm to determine that customers 306 with an interest score of two times the average customer 306 are considered to have high interest in that topic.

In one or more implementations, the present application provides functionality to “crawl” pages and discover values associated with meta tags that are provided on a user's website. Such “spider” functionality can observe particular meta tags, for example, to determine the relevancy of an article to a given customer. The information uncovered as a function of the meta tags can be stored in one or more databases, and used in connection with an algorithm to provide particular content to the given customer, as well as to analyze content in the aggregate for other customers and clients. Moreover, program code executing in one or more processors can measure content popularity, such as by page view, and can further weigh content, such as for use in one or more future communications, and to provide customized content to a respective user based on the aggregate. Users can assign or add one or more respective meta tags to the content pages of their sites, and the tags can correspond, broadly or narrowly, to the interests of users. Example meta-tags for keywords and date include:

<meta name=“sailthru.date” content=“Tue, 05 Apr 2012 23:26:57 -0400”
/>
<meta name=“sailthru.title” content=“Belichick named top coach in the
NFL” />
<meta name=“sailthru.tags” content=“sports, football, nfl, NE-patriots” />

In one or more implementations tracking code, such as written in Jquery or other suitable cross-platform script, can be embedded on pages within a client's website for tracking actions taken by one or more customers. Parameters can be included, for example, to define whether a particular web page should be crawled by a spider, whether to define a custom domain in a cookie, and whether to display meta-tag taxonomy in source code. Moreover, deprecated parameters can be defined, such as to identify particular keywords or domain meta-tags from a webpage.

Thus, the present application supports use of meta-tag information, such as to differentiate and/or determine user interests or preferences. Examples of interests or preferences can include topics or categories, types of content, brands, price ranges, and sizes and color preferences. Use of meta tag information can enable tracking of specific user interests and to provide particular content, such as in connection with custom newsletters, that can be defined for each of a plurality of respective subscribers. Content display module 414, for example, can use meta-tag data to provide specific content into the content feed of various respective email messages. For example, a processor executing code can crawl through one or more web pages, and content from a respective feed can be added into a template, such as to provide an automated newsletter with customized content for each respective subscriber to the newsletter. Further, programming code can be executed by one or more processors to display content conditionally in a template. For example, a fashion retailer has images of dresses in three colors. Visitors to the fashion retailer website view the dresses in one of the three colors, and their choices are tracked, including as a function of one or more meta-tags, and stored for future use in determining content to provide in various media, such as email messages, web sites or other media. Thereafter, as the newsletter is generated, colors that have been viewed by the respective customers can be identified, e.g., by referencing stored information representing previous actions taken by the users (e.g., viewing the dresses in the particular colors), and items in the respective newsletters can be represented appropriately in one or more particular colors.

In addition to identifying user activity within a website, the present application supports assigning location-based tags for geo-location information that can be used to determine a location of a customer. Location-based tags can be stored and later processed to provide particular and customized content to respective customers, such as in newsletters, email messages and Internet websites. Based upon processed geolocation information, for example, recommendations and other targeted communications can be generated for respective customers. In one or more implementations, program functions are supported to personalize communications based on a location, interest, activity level or the like. In one or more implementations, such functions can return a floating-point number, which can be particularly useful when combined with a control structure that allows for selecting particular content. For example, values (e.g., “scores”) can be defined to represent interest, counts and geolocation information.

In one or more implementations, the present application takes into account how recently information has been viewed, which enables interest levels of customers to be updated or otherwise altered via a formula. The formula can take into account, for example, gradual decline and fade of interests over time. For example, a formula for scoring a customer's interest may be defined as follows: (TagCountᵤₛₑᵣ/TotalCountᵤₛₑᵣ)/(TagCountₐₗₗ/TotalCountₐₗₗ), where TagCountᵤₛₑᵣ represents the number of views of the tag for that particular user, TotalCountᵤₛₑᵣ represents the total number of views of all tags for that particular user, TagCountall represents the number of views of the tag for all users and TotalCountₐₗₗ represents the total number of views of all tags for all users. This enables weighing substantially in real time of a customer's expressed interest relative to all customers' expressed interest. For example, if a customer views 10 articles about the NFL relative to 100 total articles, and all customers have viewed 10,000 articles about the NFL relative to 500,000 total views, the customer's score is: (10/100)/(10000/500000)=5.

The formula set forth above may not account for personal interests that fade or even disappear over time. Using the formula shown and described above, if a customer was reading articles about the 2012 election back in 2012, for example, then the calculation for the interest is maintained and scoring interest in Mitt Romney's calculated the same in 2014 as it was in 2012. Unfortunately, this may not accurately model the way the customer's real interests change and evolve over time. In addition, some types of businesses, such as in the travel industry, have a high seasonality, which also impacts how interests fade over time, as well as re-emerge. For example, ski vacations that were viewed in February may not be as relevant in June, but may be highly relevant in Autumn when the foliage changes color and attracts tourists. Accordingly, the present application addresses changing decay of interests.

In one or more implementations, the present application supports tag counting as well as a most recent timestamp for a given tag. Accordingly the interest score, identified above, can be altered to be: Max(0, ((TagCountᵤₛₑᵣ/TotalCountᵤₛₑᵣ)/(TagCountₐₗₗ/TotalCountₐᵢᵢ))*(1 ((MostRecentTagTime TagTime)/ClientTimeDecayFactor))), where MostRecentTagTime represents the timestamp of the most recent tag viewed by that user, which, for example, can be stored in another property such as relating to time), TagTime represents the timestamp of the particular tag, ClientTimeDecayFactor represents a client configurable value, which can default, for example, to 315360000 (i.e., one year in seconds).

In addition, or in the alternative, if (MostRecentTagTime−TagTime)>ClientDecayExpiration, then resolve to 0 regardless of the result of the above calculation. In addition, a value, ClientDecayHalflife, represents a half-life interval, defaulting to 2592000 (30 days in seconds). ClientDecayExpiration represents an expiration interval, defaulting to 315360000 (one year in seconds)

For example, to take the above score in a scenario where a customer has not viewed any tagged content in 3 months, and the last time the customer viewed content about the NFL was 6 months before that, the following score can be calculated: Max(0, ((10/100)/(10000/500000)))*(1(([3 months ago][9 months ago])/[1 year]))=˜2.5. The score of 5 “decays” to 2.5, because of the time that has elapsed since the customer last expressed that interest. In cases where TagTime is not present, TagTime can be assumed to be the same as the deploy date of this change, which will have the effect of decaying old interests that do not get revisited gradually.

In one or more implementations, a lookup page associated with a customer can be modified and/or accessed to obtain a list of interests associated with one or more users. The interests that are identified can be referenced and applied to determine or to select an appropriate decay value for one or more tags. For example, a setting in a “Recommend” section can allow a client to set a decay interval, which can default to one year but can be set to a different number of months, for example between one month and sixty months. After the set value of time passes, the content is no longer recommended.

In addition, the present application can take into account different nonlinear forms of decay, such as exponential or logarithmic decay. Capability can be provided, for example, for queries against recency of specific tags, for example “last viewed <tag> within the last 90 days.” For example, to take the above score in a scenario in which a customer has not viewed any tags in 3 months, and the last time the customer viewed content about the NFL was 3 months before that, the following score can be calculated: Max(0, ((10/100)/(10000/500000)))*(0.5̂(([3 months ago]−[6 months ago])/[1 month]))=˜0.625. In this example, the score of 5 “decays” to 0.625, because of the time that has elapsed since the customer last expressed relevant interest.

In addition to providing one or more controls for users to set values for decay, information from a plurality of sources can be accessed by one or more processors and used in connection with proposing decay values, adjusting decay values and/or setting decay values, for example. Information from a plurality of clients can be abstracted and used to identify trends and/or to predict a degree of decay for a respective tag or group of tags. Data processing apparatus 102 can identify respective contexts associated with one or more tags, such as in accordance with aggregated user profiles, information from third-party sources, or the like.

In addition, contextual information from abstracted aggregated user profiles, information from third-party sources, or other sources can be used to reflect potential sales and successful promotions within a particular time. Such contextual information can be used and integrated for use as a client defines a campaign or is setting decay values for one or more tags. As the client sets a decay value, for example 30 days, for a tag associated with a football-related promotion, a prompt may be provided that recommends a higher number, such as 90 days, with an explanation that a particular event (e.g. the beginning of playoffs) is upcoming and that could impact an accurate decay value. Thus, the present application includes functionality to reflect varying interest, as the system processes third-party data and correlates that data with various other information to arrive at an optimized decision for personalization.

The present application includes processing to account for decay of one tag at one respective rate (e.g., 30 days) and to account for another tag that decays at another rate (e.g., 90 days), for example, due to varying contexts. The present application can be configured further to automatically optimize individual tag decay rate, for example, based on demonstrated performance of the tag over time in the context of aggregated data. In addition, data processing apparatus 102 can be configured to recognize that tag decay rates oscillate for various reasons, such as based on seasonal variations, individual variations, demographics or other contexts.

For example, an individual customer may take a vacation at a particular place (e.g., Disneyworld) at a time when most people do not. In this example, historical information for the individual may outweigh third-party or aggregated data context or all information from a group. In such case, content display module 414 can operate so that the individual customer receives in an email campaign content that is directed to Disneyworld at a time of year when other customers that are recipients of the same email campaign receive content directed to school supplies.

Thus the present application provides a system and method to characterize a user's interest in accordance with a particular tag and to apply a decay rate to tags dynamically as a function of information received from third parties and/or the user's historical profile. Moreover, as a customer's behavior changes, decay values associated with one more tags can change and information can be managed to maintain relevance for customer, and information is introduced automatically. Further, the present application operates to process information received from a user that represents active selections (e.g., clicks, hovering, selections or other input), and well as inactive information (e.g., geo-location information, time-based information, information from third parties, aggregate information from other customer profiles) in order to transform that information, including to identify particular content to provide to a particular user or to a group of users in various contexts (e.g., e-mail messages, web sites, or other interactive media).

Although the present invention has been described in relation to particular embodiments thereof, many other variations and modifications and other uses will become apparent to those skilled in the art. For example, although many of the descriptions and examples set forth herein relate to still images, the application is not so limited. It is preferred, therefore, that the present invention not be limited by the specific disclosure herein.

What is claimed:

1. A computer-implemented method, comprising:
accessing, by a processor configured by executing code, electronic activity information representing activity of a plurality of respective users of each of a plurality of Internet web sites and a time associated with the activity;
accessing, by a processor configured by executing code, electronic user geo-location information representing at least a location of a respective device operated by each of the plurality of respective users;
processing, by a processor configured by executing code, the electronic activity information to determine a respective interest of each of the respective users;
generating, by a processor configured by executing code, a respective targeted communication for each of the plurality of respective users by:
calculating a decay value representing a decline of the determined interests of the respective users;
weighting the respective determined interests of the plurality of users to represent the decline of the determined interests as a function of the calculated decay value; and
selecting respective content for inclusion in the targeted communication for each of respective users as a function of the electronic activity information, the user geo-location information and the weighted respective determined interests; and
transmitting, by a processor configured by executing code, to each respective one of the plurality of users, the generated respective targeted communication, wherein the targeted communication is distributed via a communication device over a data-communication network.

2. The method of claim 1, wherein the electronic activity information includes at least one of:
a number of views of particular tagged content by one of the respective user (“TagCountᵤₛₑᵣ”);
a number of views of particular tagged content by the plurality of respective users (“TagCountₐₗₗ”);
a number of views of all tagged content on one of the plurality of Internet web sites by the one respective user (“TotalCountᵤₛₑᵣ”); and
a number of views of all tagged content on the one of the plurality of Internet web sites by the plurality of respective users (“TotalCountₐₗₗ”).

3. The method of claim 2, wherein the step of processing the electronic activity information to determine the respective interest of each of the respective users comprises calculating, by a processor:
(TagCountᵤₛₑᵣ/TotalCountᵤₛₑᵣ)/(TagCountₐₗₗ/TotalCountₐₗₗ).

4. The method of claim 2,
wherein the calculated decay value represents a measurement of time (“ClientTimeDecayFactor”),
wherein the electronic activity information further includes a timestamp when a respective user most recently viewed tagged content (“MostRecentTagTime”);
and further wherein the electronic activity information further includes a timestamp when a respective user the viewed particular tagged content (“TagTime”).

5. The method of claim 4, wherein the step of processing the electronic activity information to determine the respective interest of each of the respective users comprises calculating, by a processor:
Max(0,(TagCountᵤₛₑᵣ/TotalCountᵤₛₑᵣ)/(TagCountₐₗₗ/TotalCountₐₗₗ)*(1(MostRecentTagTime/Tag Time)/ClientTimeDecayFactor)).

6. A computer-implemented system, comprising:
processor readable media;
a processor operatively coupled to the one or more processor readable media and configured to access at least one database;
the one or more processor readable media having instructions for causing the following steps to be performed by the processor:
access electronic activity information representing activity of a plurality of respective users of each of a plurality of Internet web sites and a time associated with the activity;
access electronic user geo-location information representing at least a location of a respective device operated by each of the plurality of respective users;
process the electronic activity information to determine a respective interest of each of the respective users;
generate a respective targeted communication for each of the plurality of respective users by:
calculating a decay value representing a decline of the determined interests of the respective users;
weighting the respective determined interests of the plurality of users to represent the decline of the determined interests as a function of the calculated decay value; and
selecting respective content for inclusion in the targeted communication for each of respective users as a function of the electronic activity information, the user geo-location information and the weighted respective determined interests; and
transmit to each respective one of the plurality of users, the generated respective targeted communication, wherein the targeted communication is distributed via a communication device over a data-communication network.

7. The system of claim 6, wherein the electronic activity information includes at least one of:
a number of views of particular tagged content by one of the respective user (“TagCountᵤₛₑᵣ”);
a number of views of particular tagged content by the plurality of respective users (“TagCountₐₗₗ”);
a number of views of all tagged content on one of the plurality of Internet web sites by the one respective user (“TotalCountᵤₛₑᵣ”); and
a number of views of all tagged content on the one of the plurality of Internet web sites by the plurality of respective users (“TotalCountₐₗₗ”).

8. The system of claim 7, wherein the step of processing the electronic activity information to determine the respective interest of each of the respective users comprises calculating, by a processor:
(TagCountᵤₛₑᵣ/TotalCountᵤₛₑᵣ)/(TagCountₐₗₗ/TotalCountₐₗₗ).

9. The system of claim 7,
wherein the calculated decay value represents a measurement of time (“ClientTimeDecayFactor”),
wherein the electronic activity information further includes a timestamp when a respective user most recently viewed tagged content (“MostRecentTagTime”);
and further wherein the electronic activity information further includes a timestamp when a respective user the viewed particular tagged content (“TagTime”).

10. The system of claim 9, wherein the step of processing the electronic activity information to determine the respective interest of each of the respective users comprises calculating, by a processor:
Max(0,(TagCountᵤₛₑᵣ/TotalCountᵤₛₑᵣ)/(TagCountₐₗₗ/TotalCountₐₗₗ)*(1(MostRecentTagTime/Tag Time)/ClientTimeDecayFactor)).
